(19) United States
(12) Patent Application Publication
(10) Pub. No.: US 2026/0142888 A1
(43) Pub. Date: May 21, 2026

(54) NATURAL LANGUAGE DETERMINISTIC NETWORK TROUBLESHOOTING AND CONFIGURATION TOOLS

(71) Applicant: Cisco Technology, Inc., San Jose, CA (US)

(72) Inventors: Yathiraj Bhat Udupi, San Jose, CA (US); Elango Ganesan, Portola Valley, CA (US); Aniruddh S. Dikhit, San Jose, CA (US); Akshay Khushu, Fremont, CA (US)

(21) Appl. No.: 19/046,075

(22) Filed: Feb. 5, 2025

Related U.S. Application Data
(60) Provisional application No. 63/720,987, filed on Nov. 15, 2024.

(51) Int. Cl. H04L 41/16; G06F 16/242; H04L 41/5019

(52) U.S. Cl. CPC H04L 41/16; G06F 16/243; H04L 41/5019

(57) ABSTRACT

Methods involve obtaining a natural language input query related to a technical issue in a network and a natural language description of a set of configuration actions for resolving the technical issue and generating, using a first artificial intelligence (AI) model, a multi-step configuration schema based on the natural language input query and the natural language description of the set of configuration actions. The multi-step configuration schema includes a plurality of configuration actions, each of which is described in a natural language and in a structured form including a function and input parameters for the function. The methods further involve providing the multi-step configuration schema to a second AI model that connects to one or more network devices in the network and executes, on the one or more network devices, the plurality of configuration actions in the multi-step configuration schema to resolve the technical issue in the network.

### CROSS-REFERENCE TO RELATED APPLICATION(S)

This application claims the benefit of priority under 35 U.S.C. § 119 (e) to U.S. Provisional Application No. 63/720,987, filed on Nov. 15, 2024, which is hereby incorporated by reference in its entirety.

### TECHNICAL FIELD

The present disclosure relates to computer networking, data management, and data communications.

### BACKGROUND

Network management is a desirable feature as the modern internet infrastructure has exponentially grown in past decades. Typically, network management involves handling large amounts of inflowing requests including but not limited to ticketing, case alarms, operational reporting, and knowledge sharing. Artificial intelligence (AI) and machine learning (ML) models are being integrated into the network management field to assist Information Technology (IT) specialists in managing networks. AI/ML models may be deployed to help track network performance, troubleshoot a network problem, integrate a new technology, and/or upgrade deployed network devices. Because of the complexities in modern networks, these operations are typically a multi-step workflow. While AI/ML models may help generate the multi-step workflow for troubleshooting and/or configuring complex networks, their utility is suspect sometimes because AI/ML models are subject to hallucinations. Existing solutions are error prone in part due to complexities of modern networks.

### BRIEF DESCRIPTION OF THE DRAWINGS

FIG. 1A is a diagram depicting an environment in which a multi-step configuration schema generator and a network virtual assistant are deployed to perform troubleshooting of network/computing equipment in network(s), according to an example embodiment.

FIG. 1B is a diagram depicting an operational flow in which the network virtual assistant of FIG. 1A generates a response to a user query based on a generated multi-step configuration schema, according to an example embodiment.

FIGS. 2A and 2B are diagrams depicting the multi-step configuration schema generator of FIG. 1A generating a multi-step configuration schema, according to one or more example embodiments.

FIG. 3 is a diagram depicting an operational flow by which the network virtual assistant of FIG. 1A performs troubleshooting to solve a technical issue using a multi-step configuration schema, according to an example embodiment.

FIG. 4 is a diagram depicting an operational flow in which a runtime feedback loop is performed for improved accuracy in troubleshooting a technical issue, according to an example embodiment.

FIG. 5 is a flowchart illustrating a method of generating and performing a multi-step configuration schema in which configuration actions are executed on network devices to resolve a technical issue in a network, according to one or more example embodiments.

FIG. 6 is a flowchart illustrating a method of troubleshooting a technical issue in a network by connecting to network devices and performing operations of a multi-step configuration schema on these devices, according to one or more example embodiments.

FIG. 7 is a hardware block diagram of a computing device that may perform functions associated with any combination of operations in connection with the techniques depicted and described in FIGS. 1A, 1B, 2A, 2B, and 3-6, according to various example embodiments.

### DESCRIPTION OF EXAMPLE EMBODIMENTS

### Overview

Briefly, a multi-step configuration schema generator performs function matching and argument placement for AI/ML aided troubleshooting, and a network virtual assistant executes configuration actions on network devices, interprets results of the performed troubleshooting, and outputs a response.

In one form, the techniques presented herein involve obtaining a natural language input query related to a technical issue in a network and a natural language description of a set of configuration actions for resolving the technical issue in the network and generating, using a first artificial intelligence (AI) model, a multi-step configuration schema based on the natural language input query and the natural language description of the set of configuration actions. The multi-step configuration schema includes a plurality of configuration actions, each of which is described in a natural language and in a structured form including a function and input parameters for the function. The techniques further involve providing the multi-step configuration schema to a second AI model that connects to one or more network devices in the network and executes, on the one or more network devices, the plurality of configuration actions in the multi-step configuration schema to resolve the technical issue in the network.

In another form, the techniques presented herein involve obtaining a troubleshooting query related to a technical issue in a network. The troubleshooting query is in a natural language format. The techniques further involve determining a multi-step configuration schema based on the troubleshooting query. The multi-step configuration schema is generated by a first artificial intelligence (AI) model augmenting each step of the multi-step configuration schema in a natural language description with a function and corresponding input parameters for the function. The techniques further involve executing, by a second AI model, the multi-step configuration schema by connecting to one or more network devices in the network and performing a plurality of operations on the one or more network devices, to generate a response to the troubleshooting query.

### EXAMPLE EMBODIMENTS

A network management system may involve the management of network assets (routers, switches, gateways, servers, etc.), technical issue cases (errors or issues to troubleshoot in a network), an automation workbench, insights learned from observation of the network or other similar networks, etc. Troubleshooting is typically a multi-step or a multi-task action plan in which executable tasks are performed on network devices to resolve a network problem. The multi-step action plan may involve a set of configuration actions related to a technical issue or problem in a network. An outcome of these configuration actions is typically reported to a user. Configuration actions or executable tasks may involve gathering telemetry or key performance indicators (KPIs) with respect to network devices, changing a configuration of affected network device(s), and other actions.

Due to recent advances in artificial intelligence (AI) and machine learning (ML), troubleshooting may be performed using AI tools and/or ML tools. For example, Large Language Models (LLMs) demonstrate astonishing performance for natural language processing (NLP) of textual prompts or queries. As such, an LLM based agentic network troubleshooting system may be deployed that relies on a plurality of LLM agents to solve multi-step network troubleshooting workflow plans. These troubleshooting plans may be written in a natural language (NL) form.

Specifically, a network troubleshooting bot (also referred to as a main LLM agent) receives a user input and generates a multi-step network troubleshooting workflow. The network troubleshooting bot interacts with various LLM agents that help execute each step in the troubleshooting workflow by performing a function lookup to find matching function(s) for each step. In some cases, an LLM agent may output results of the executed step, which the network troubleshooting bot outputs to a user as a natural language summary report.

This troubleshooting process can be complicated, making it particularly challenging for AI models. LLM agents may hallucinate and retrieve incorrect function(s) or may incorrectly input arguments for each function. ML/AI models cannot always be trusted to generate and/or execute network troubleshooting workflows. Moreover, a network troubleshooting bot may misinterpret results and output an inaccurate and/or incomplete summary. For example, the network troubleshooting bot may output an indication that a network problem is resolved when AI agents indicated that the network problem is only partially resolved.

As an example, a user natural language prompt may be “an access point with media access control (MAC) address XX:5D:A8:YY:99:00 is having some issues. Please troubleshoot this access point device.” The network troubleshooting bot may generate a multi-step troubleshooting workflow in a natural language format such as:
Step 1: Get details of the network device such as noise, interference, channel, band, etc.
Step 2: Get the radio frequency (RF) details of the access point.
Step 3: Analyze the neighbors and rogue devices present in each band of 2.4 GHz, 5 GHz, and 6 GHz.
Step 4: Summarize results.

The LLM agents act on each configuration action or step iteratively, by performing a function lookup in a Retrieval Augmented Generation (RAG) vector database and then the LLM agent suggested functions are called to pass the output to the subsequent step executions. The network troubleshooting bot responds with a summary of the results. In one example embodiment, the troubleshooting bot may resolve the network problem and respond indicating whether the network problem is resolved, such as the access point is reconfigured to “X” for a certain access point function.

However, there are many challenges with this approach. Specifically, challenges are encountered in function lookup operations, such as when searching for a function in the RAG vector database. LLM agents may hallucinate with an incorrect function matching or incorrect slot selections for the arguments to be passed to the functions. Complex Application Programing Interface (API) functions with multiple input query parameters complicate slot filling for the LLM agents. Moreover, many functions have overlapping descriptions for RAG context leading to poor RAG retrievals and inconsistencies. Similar API functions or duplicating a functionality (legacy deprecated versions along with the new ones), may also lead to context collisions and cause an inconsistent behavior of the LLM agents. Because of these challenges, manual curation of the API set and specifications is used in some solutions to fix LLM agents' hallucinations. Manual curations are time consuming and can be error prone.

Further, if more tools are bound to an LLM, without strict prompt guidelines and boundary restrictions specified in the prompt, hallucinations and incorrect tool selections in the main orchestrator/plan executor agent may occur. That is, the network troubleshooting bot may also hallucinate and select incorrect LLM agents.

Additionally, hallucinations may occur in the output of the results. The network troubleshooting bot may output final interpretations, conclusions, and/or summarizations that are incomplete and/or incorrect. Specifically, based on data gathered by the network troubleshooting bot after various iterations with the LLM agents, the network troubleshooting bot provides the final answer. The network troubleshooting bot may also hallucinate based on its level of understanding of different aspects from the function calling output JavaScript Objection Notations (JSONs). The network troubleshooting bot is dependent on the domain knowledge on which it has been pre-trained. As such, the network troubleshooting bot may derive incorrect conclusions by misinterpreting the meaning of the API response data output by the LLM agents.

The techniques presented herein address one or more of the above-noted challenges. For example, the techniques presented herein tie the network troubleshooting bot (the main LLM) to a specific domain knowledge set to avoid incorrect conclusions or output summaries. Additionally, the techniques presented herein ensure that at a function lookup phase, the LLM agents deterministically select correct functions without hallucinations for each step or task of the multi-step natural language troubleshooting workflow. Moreover, the techniques presented herein ensure that slots or input parameters are properly filled in for various functions even when these functions include optional fields or arguments. Further, the techniques presented herein ensure that correct fields from intermediate response JSONs are selected and used for subsequent configuration action steps by the LLM agents.

The techniques presented herein provide a unique approach to LLM function calling of multi-step natural language execution workflows by refining natural language troubleshooting workflow with explicit function names, input parameters, and expected output fields. The techniques presented herein help LLM agents with reflection support to provide more determinism in function selection without any scope for hallucinations in both function selections and slot filling, and thus ensuring that the correct input and output JSON arguments are used for configuration actions in the output natural language configuration action set. Additionally, the techniques presented herein bound the troubleshooting bot to correctly interpret the results of executing a multi-step configuration schema. As such, manual curation is no longer needed and accuracy is improved.

Specifically, the techniques presented herein provide a multi-step configuration schema generator that performs function matching and input parameters placement, and a network virtual assistant that executes and correctly interprets results of executing the multi-step configuration schema. The network virtual assistant may output a natural language summary of troubleshooting actions that were performed in a network. The techniques presented improve the technical field of network troubleshooting by improving determinism, reducing latency of execution, and providing a cost savings using smaller efficient LLM models for executing the generated multi-step configuration schema with various configuration actions or operations to be performed on the network devices.

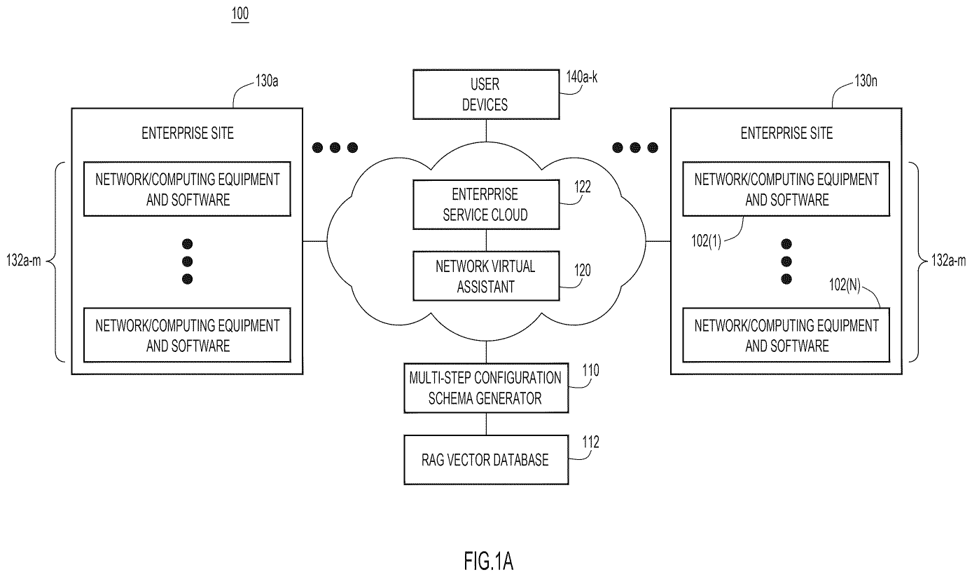

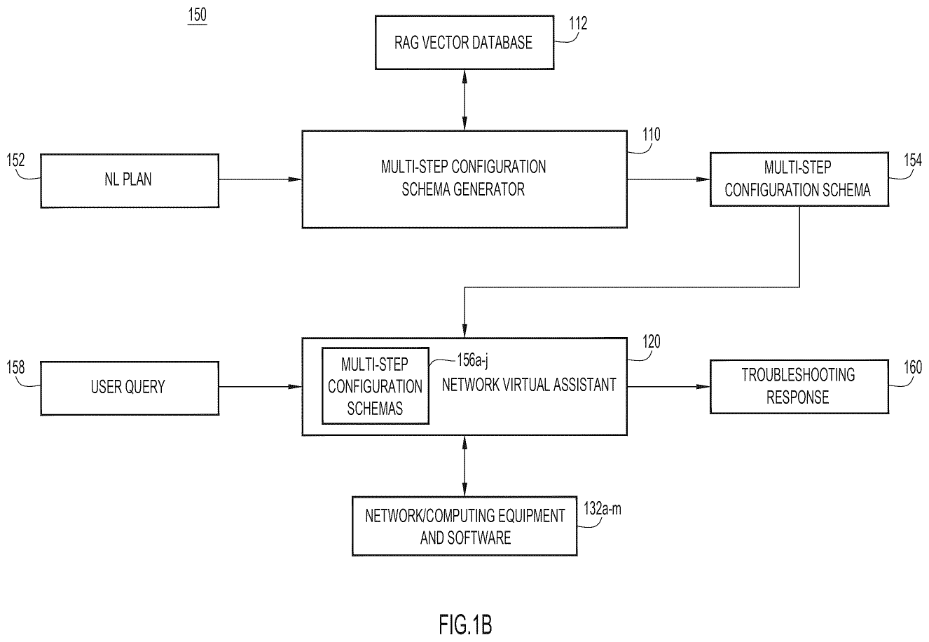

Turning now to FIG. 1A, FIG. 1A is a diagram illustrating an environment 100 in which a multi-step configuration schema generator and a network virtual assistant are deployed to perform troubleshooting of network/computing equipment in network(s), according to an example embodiment. The environment 100 includes a multi-step configuration schema generator 110 that generates a multi-step configuration schema using function metadata in a Retrieval Augmented Generation (RAG) vector database 112 and a network virtual assistant 120 that interacts with an enterprise service cloud 122 and enterprise sites 130a-n having network computing equipment and software 132a-m to perform troubleshooting based on the multi-step configuration schema.

The multi-step configuration schema generator 110 may be a large AI model such as an LLM. As another example, the multi-step configuration schema generator 110 may be an Open AI Generative Pre-trained Transformer (GPT) 4. The multi-step configuration schema generator 110 receives a natural language (NL) description of a set of configuration actions for resolving a technical issue in a network such as an NL multi-step schema or an NL plan and generates a multi-step configuration schema. In particular, based on steps described in the NL plan, the multi-step configuration schema generator 110 performs a function lookup in the RAG vector database 112 and retrieves a function based on a natural language description of the step. The multi-step configuration schema generator 110 then augments the description with corresponding retrieved function and input parameters for the function to generate a multi-step configuration schema.

The RAG vector database 112 is a structured datastore or a memory that is populated with function metadata. Function metadata includes a name of a function, a natural language description of the functions (its purpose), input arguments and schema, expected output fields, and synthesized sample user prompts that match the function along with example function calls with JSON input arguments and JSON output field list. The RAG vector database 112 or a datastore includes metadata for any of a variety of formats, such as supported Representational State Transfer (REST) API specifications, supported command line interface (CLI) functions, and Yet Another Next Generation (YANG) model lookup-based functions, and any other supported network functions. For example, a synthesized Python System Development Kit (SDK) may generate the metadata for each function and thus create a function library stored in the RAG vector database 112.

The network virtual assistant 120 is an example of a refined plan executor or the network troubleshooting bot, discussed above. The network virtual assistant 120 is an example of the main AI model that interacts with various AI agents to perform function lookups/calls/executions. The network virtual assistant 120 is a smaller AI model than the multi-step configuration schema generator 110. In one example embodiment, the network virtual assistant 120 is a local LLM model or a small Llama 3 model. The network virtual assistant 120 may be different AI model(s) and the type of an AI model being deployed may depend on a specific use case scenario.

The network virtual assistant 120 interacts with network devices to perform troubleshooting. The network virtual assistant 120 provides output generated by a first function as input into a subsequent second function, and then interprets the outcome of executions (network trace output or a trace file) to generate a response that describes the results of performing the troubleshooting. In one example embodiment, the trace file or the execution trace may be added to the response. The network virtual assistant 120 deterministically selects one of multi-step configuration schemas generated by multi-step configuration schema generator 110 based on a user query, and performs functional calls (API calls, CLIs, Yang, etc.) to generate this response to the troubleshooting query. The network virtual assistant 120 may detect and resolve a technical issue, which varies depending on device type(s). The network virtual assistant 120 may initiate troubleshooting on an apparatus based on the user query.

The network virtual assistant 120 interacts with enterprise service cloud 122 and/or network/computing equipment and software 132a-m residing at various enterprise sites 130a-n to perform troubleshooting. That is, the network virtual assistant 120 may use various executor agents to perform functions in the multi-step configuration schema by connecting to network/computing equipment and software 132a-m and performing various operations on these network devices or apparatuses, in order to generate a response to a troubleshooting query.

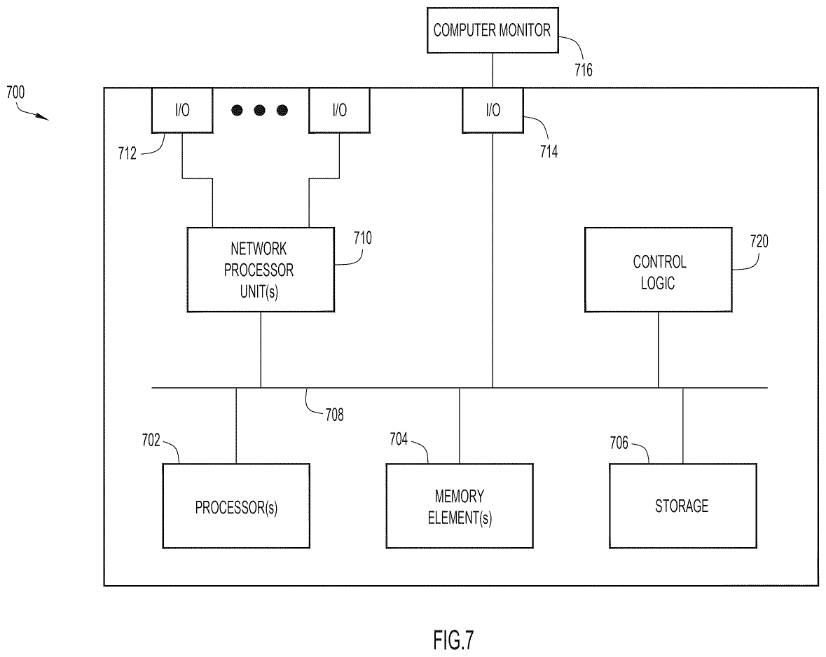

The enterprise service cloud 122 may be executed by one or more servers or a computing apparatus, shown in FIG. 7. In one example embodiment, the enterprise service cloud 122 and the network virtual assistant 120 are integrated into one network management platform.

The enterprise service cloud 122 is driven by human and digital intelligence that serves as a one-stop destination for equipment and software of an enterprise to access insights and expertise when needed and to perform troubleshooting. Examples of capabilities include assets and coverage, cases (network errors or technical issues to troubleshoot), an automation workbench, insights with respect to detected anomalies and fixes for technical issues, and so on. The enterprise service cloud 122 helps enterprise network technologies to be assessed based on telemetry and contextual learning, support content, expert resources, and analytics and insights. The enterprise service cloud 122 threads data from multiple disparate sources into a contextualized digital representation of the enterprise's IT environment via a portfolio of hardware/software assets and services from one or more providers.

The enterprise service cloud 122 may provide various telemetry data associated with an enterprise network to the network virtual assistant 120 based on the multi-step configuration schema. The enterprise service cloud 122 may collect information about enterprise assets and the enterprise network based on the telemetry data and collect information about various upgrades and/or migration options (available software upgrade information). The enterprise service cloud 122 may aid network virtual assistant 120 with establishing various connections to the network/computing equipment and software 132a-m using different function calls and protocols such as CLIs and/or API calls.

The network/computing equipment and software 132a-m are resources or assets of an enterprise network (the terms “assets” and “resources” are used interchangeably herein). The network/computing equipment and software 132a-m may include any type of network devices or network nodes such as controllers, access points, gateways, switches, routers, hubs, bridges, gateways, modems, firewalls, intrusion protection devices/software, repeaters, servers and data storage equipment. The network/computing equipment and software 132a-m may further include endpoint or user devices such as a personal computer, laptop, and tablet. The network/computing equipment and software 132a-m may include various devices that receive and send packets in the network using a network interface. The network/computing equipment and software 132a-m may include virtual nodes such as virtual machines, containers, point of delivery (POD), and software such as system software (operating systems), firmware, security software such as firewalls, and other software products. Associated with the network/computing equipment and software 132a-m is configuration data representing various configurations, such as enabled and disabled features, parameters of various functions, etc. The network/computing equipment and software 132a-m, located at the enterprise sites 130a-n, represent an information technology (IT) environment of an enterprise.

The enterprise sites 130a-n may be physical locations such as one or more data centers, facilities, or buildings located across geographic areas that are designated to host the network/computing equipment and software 132a-m. The enterprise sites 130a-n may further include one or more virtual data centers, which are a pool or a collection of cloud-based infrastructure resources specifically designed for enterprise needs, and/or for cloud-based service provider needs. In the environment 100, by way of an example, an enterprise site 130a and an enterprise site 130n are depicted.

The network/computing equipment and software 132a-m may send to the enterprise service cloud 122, via telemetry techniques, data about their operational states and configurations so that the enterprise service cloud 122 may be continuously updated about the operational states, configurations, software versions, etc., of each instance of the network/computing equipment and software 132a-m.

User devices 140a-k may be any endpoint devices such as a personal computer, laptop, and tablet. IT specialists may use the user devices 140a-k to interact with the network virtual assistant 120 and/or the enterprise service cloud 122. For example, a user may input a user query to the network virtual assistant 120 for performing a troubleshooting action, fixing a technical issue in the network such as a failed network connection or a malfunctioning network device, etc. In one example embodiment, user devices 140a-k may reside on one of the enterprise sites 130a-n and may be part of network/computing equipment and software 132a-m. The user devices 140a-k are also configured to receive and send packets in a network.

Turning now to FIG. 1B, with continued reference to FIG. 1A, an operational flow 150 is shown in which the network virtual assistant 120 generates a response to a user query based on a multi-step configuration schema generated by the multi-step configuration schema generator 110, according to an example embodiment. The operational flow 150 involves the multi-step configuration schema generator 110 receiving a NL plan 152 and generating a multi-step configuration schema 154 using function metadata stored in the RAG vector database 112. The operational flow 150 further involves the network virtual assistant 120 receiving a user query 158 and generating a troubleshooting response 160 using one of the multi-step configuration schemas 156a-k to make function calls to network/computing equipment and software 132a-m in network(s), and thus performing troubleshooting to resolve a technical issue.

Specifically, the multi-step configuration schema generator 110 analyzes each step of the NL plan 152 and the natural language description of the configuration actions in the step and uses function metadata in the RAG vector database 112 (or datastore) to augment each step with function call, input parameters, and expected output fields. By augmenting each step with an executable function, the multi-step configuration schema 154 is generated. The multi-step configuration schema 154 includes for every step or configuration operation in the NL plan 152, an explicit function name and/or identification, input parameters, expected user query, and expected output fields. The multi-step configuration schema generator 110 obtains any missing input parameters using follow-up queries.

For example, if a step in the NL plan 152 states “get details of the access point X”, this step in the multi-step configuration schema 154 includes:

{step # 1 : [
{
“step_description”: “Get the details of the access point.”,
“function_name”: “get_ap_details_by_mac_address”,
“input_arguments”: [“mac_address”],
“output_fields”: [“$.response.noise”, “$.response.interferenceScore”,
“$.response.overallHealth”, “$.response.cpu”]
}...

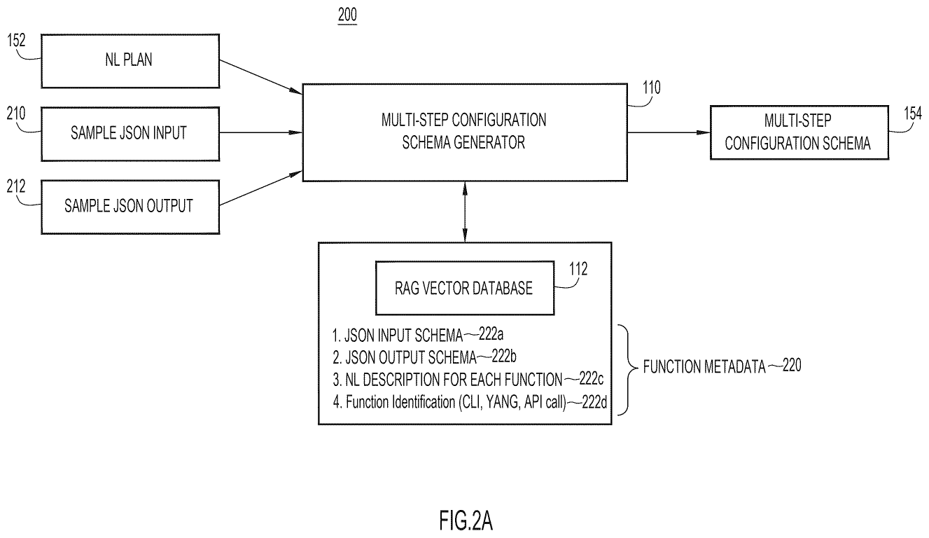

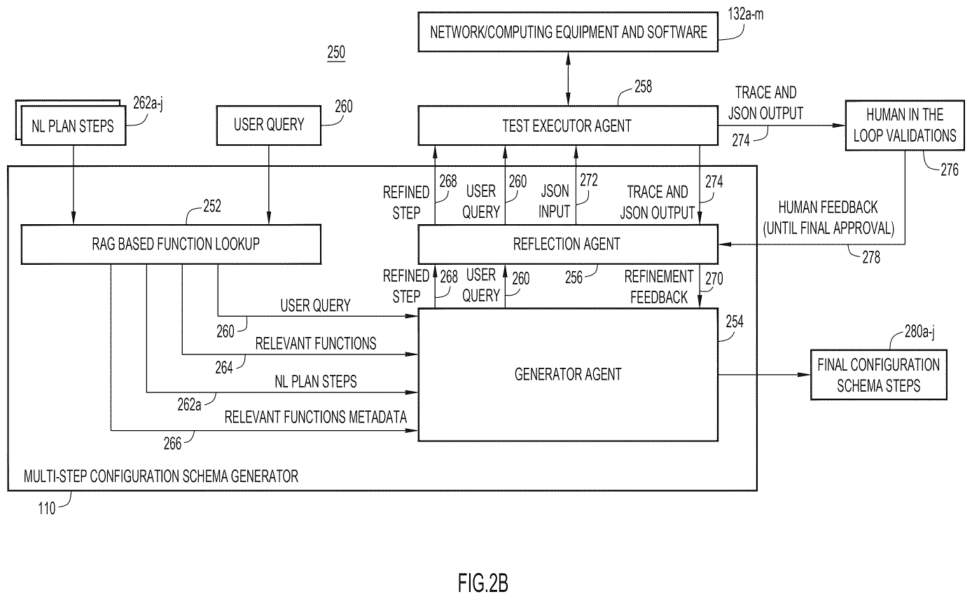

The multi-step configuration schema generator 110 generates a plurality of multi-step configuration schemas 156a-j, described in FIGS. 2A and 2B below, which are then used by the network virtual assistant 120 to generate the troubleshooting response 160.

The user query 158 is a natural language prompt that is input into the network virtual assistant 120. In one example embodiment, the user query 158 is generated by a network management platform based on a technical issue in a network. For example, the enterprise service cloud 122 may generate the user query 158 based on detecting a technical issue on one of the enterprise sites 130a-n. A technical issue may be an outage, a latency problem, a connectivity problem, a malfunction in a network device or software thereon, and/or incompatibility or configuration related problems for connections. The technical issue may involve defects, obsolescence, configurations, workarounds, network patches, etc. The technical issue may relate to security vulnerabilities, upgrades, etc.

To address the technical issue(s), troubleshooting is performed. Troubleshooting may be initiated automatically, such as by one of the network/computing equipment 132a-m. For example, a network controller may generate a troubleshooting natural language prompt and provide it to the network virtual assistant 120. Typically, however, troubleshooting is initiated by a user, e.g., an IT specialist, by providing the user query 158 to the network virtual assistant 120. Troubleshooting may be reactive (a network problem is detected) or proactive, such as based on an observed trend (high volume of data in an input and/or output buffer in the network device).

Troubleshooting involves interacting with network/computing equipment and software 132a-m, which may include different hardware and software that host network services (e.g., product families, asset groups) and which may run different features and configurations to enable network services. Troubleshooting of the network/computing equipment 132a-m involves accounting for these differences, especially when they include configuration operations or actionable commands for a particular network device. Configuration actions may involve commands for changing the configuration of the one or more affected network devices. For example, configuration actions may resolve a technical issue (a ticketing task), solve a security related vulnerability (security resolution task), enable or disable one or more network features, such as enable a particular feature on a group of network devices. Configuration actions may involve gathering information such as telemetry data and/or key performance indicators (KPIs). These are just some non-limiting examples of various actionable tasks, executable operations, or configuration actions that may be performed in the network domain.

The configuration of the network/computing equipment and software 132a-m may be changed by establishing a connection with each of the one or more affected network devices using an application programming interface (API) and reconfiguring hardware or firmware on a respective network device using commands. For example, a first device may be reconfigured using a command line interface (CLI) call, a second device may provide its telemetry data using a YANG model, and a third device may be reconfigured to use port A instead of port B via several application programming interface calls. Further, the network/computing equipment and software 132a-m may provide data about their operational status and configurations so that the network virtual assistant 120 is updated about the operational status, configurations, software versions, etc. of each instance of the network/computing equipment and software 132a-m and may respond to user troubleshooting queries related to technical issues and/or states of network/computing equipment and software 132a-m.

The network virtual assistant 120 generates the troubleshooting response 160 based on a selected one of the multi-step configuration schemas 156a-j. By using the selected multi-step configuration schema, the network virtual assistant 120 performs a plurality of operations on one or more network devices to generate a response to the user query 158. The network virtual assistant 120 accurately interprets outcomes of various sequential configuration actions or actionable tasks performed because it is trained to understand response data.

In one example embodiment, the network virtual assistant 120 may generate a natural language summary that describes the outcome of troubleshooting and further adding an output trace or a trace file to the summary. For example, the troubleshooting response 160 may be: (a) high latency in a network device A is detected, (b) a failure of path B is detected, (c) reconfigured access point to avoid congestion, and (d) changed traffic to a different port on the network device A. The troubleshooting response 160 may describe configuration actions performed in a natural language format and/or changes in the state or operations of the network/computing equipment and software 132a-m. Additionally, the troubleshooting response 160 may indicate that the technical issue is resolved, partially resolved, not resolved, and/or not detected.

While in example embodiments described below, the AI models are described as LLMs, this is just an example. Some non-limiting examples of AI/ML models include unsupervised machine learning, supervised machine learning, deep neural networks, generative adversarial network, other LLMs such as recurrent neural networks, generative pre-trained transformers, bidirectional encoder representations from transformers (BERT), text-to-text transfer transformers (T5).

Reference is now made to FIGS. 2A and 2B, with continued reference to FIGS. 1A and 1B. FIGS. 2A and 2B are diagrams depicting the multi-step configuration schema generator 110 generating a multi-step configuration schema 154, according to one or more example embodiments.

Specifically, FIG. 2A is a diagram depicting an operational flow 200 in which the multi-step configuration schema generator 110 generates the multi-step configuration schema 154, according to an example embodiment. In the operational flow 200, the multi-step configuration schema generator 110 obtains as input the NL plan 152, a sample JSON input 210, a sample JSON output 212, and using information in the RAG vector database 112 generates the multi-step configuration schema 154.

As noted above, conventional agentic workflow systems may not be stable and same input query may result in different outputs. In one or more example embodiment, the multi-step configuration schema generator 110 performs refinements that may improve the stability of an agentic workflow. For example, a refinement may be to add a custom LLM instruction on a step-by-step basis. Other refinements may include performing intent to function binding, providing an LLM structured output, performing context window reduction, and executing dependency mapping with an LLM compiler, as detailed below.

In one example embodiment, the agentic workflow includes a scheduler agent that directs the workflow to another agent such as a data gathering agent, a reasoning agent, or a reflection agent. The data gather agent may execute function calls to network/computing equipment and software using various network protocols such as command line interface (CLI), Yet Another Next Generation (YANG) model, Representational State Transfer (REST) call, Network Configuration Protocol (Netcong) command, etc. The reasoning agent may determine network problems or operational states based on the gathered data. The reflection agent may direct troubleshooting and/or configuration actions and reflect on whether a network problem was resolved.

Each natural language plan (the NL plan 152) is a series of steps or tasks. The steps describe configuration actions in a natural language form. In one example embodiment, the NL plan 152 may be a troubleshooting runbook designed in a natural language format. Each step is expected to be answered by an LLM system by invoking a function looked up from a set of available and registered functions in a datastore. The function is called by passing an appropriate set of input arguments based on the JSON input schema, and the output is to be passed on to execute subsequent steps and is also based on a JSON output schema.

For example, if the NL plan 152 is for a wireless access point troubleshooting, the NL plan 152 may be as follows:
Step 1: Get the details of the device such as noise, interference, channel, band etc.
Step 2: Get the RF details of the access point.
Step 3: Analyze the neighbors and rogue devices present in each band of 2.4 GHz, 5 GHz, and 6 GHz.
Step 4: Summarize the results.

The multi-step configuration schema generator 110 transforms this wireless access point troubleshooting plan into the multi-step configuration schema 154. In this example, the multi-step configuration schema 154 may have the following form:
Step 1—Refined: Get details of the device such as noise, interference, channel, band, etc. using function specified as: <function_name: getDeviceDetailByID> using the input arguments <arguments_list: [id,]> and extract the output fields <output_fields_list: [noise, interference, channel, band, . . . ]>
Step 2—Refined: Get the RF details of the access point using function specified as: <function_name: get_ap_rf_details> using the input arguments: <arguments_list: [id]> and extract the output fields <output_fields: [rssi, snr, retries, drops, . . . ]
Step 3—Refined: Analyze the neighbors and rogue devices present in each frequency band of 2.4 GHz, 5 GHZ, and 6 GHz using the function specified as: <function_name: get_neighbors_and_rogues_per_band> using the input arguments <arguments_list: [id, band]> and extract the output fields <output_fields_list: [neighbors_count, rogues_count].
Step 4—Refined: Summarize the results using the outputs gathered from Step 1, Step 2, and Step 3 including a network trace output if applicable using the function specified as: [function_name: “summarize results”, “input arguments <argument_list: [ ], and extract the output fields <output_fields_list: {“$.summary”}.

For each configuration action in the NL plan 152, the multi-step configuration schema generator 110 performs a RAG-based function lookup operation in the RAG vector database 112 or datastore. That is, the multi-step configuration schema generator 110 uses a natural language description of the configuration action in the NL plan 152 to determine a relevant function or function(s) in the RAG vector database 112, which stores function metadata 220 including JSON input schema 222a, a JSON output schema 222b, a NL description of each function 222c, and a function identification 222d. The function identification 222d may identify the function by its name and command such as a command line interface function, application programming interface call, or a data modeling language function.

Based on the JSON input schema 222a in the retrieved function, the multi-step configuration schema generator 110 may determine whether any of the input parameters are missing by extracting data from a natural language input query or from an output of performing a preceding configuration action. If data is missing at least one value for the input parameters, the multi-step configuration schema generator 110 may generate a follow-up query to obtain the missing value(s) based on the sample JSON input 210. If the response received does not match the sample JSON output 212, new follow-up queries may be generated based on the sample JSON input 210. In other words, the multi-step configuration schema generator 110 ensures that there are no missing values for the input parameters of the selected function. As such, the multi-step configuration schema generator 110 performs function binding and slot filling for the input parameters.

Using the relevant function and JSON input schema 222a, the multi-step configuration schema generator 110 generates the output that should match the JSON output schema 222b. If the outputs do not match, the multi-step configuration schema generator 110 tries another function from the RAG vector database 112. Using the function metadata 220, the multi-step configuration schema generator 110 selects a function for each configuration action/operation in the NL plan 152. That is, each step is augmented with a corresponding function and input parameters for the corresponding function. Values for the input parameters are obtained using output from performing preceding configuration actions and/or follow-up queries, as needed.

To ensure that a proper function is selected for each configuration action, the multi-step configuration schema generator 110 iteratively regenerates each step in the configuration schema using a feedback loop, detailed in FIG. 2B. That is, the multi-step configuration schema 154 is validated by iteratively regenerating functions in the steps based on whether the network output trace matches expected output (resolves the technical issue).

In one example embodiment, the multi-step configuration schema generator 110 is further configured to generate and add custom LLM instructions for processing or parsing output data from a function. That is, the multi-step configuration schema generator may determine whether the step is a data gathering step or a reasoning step and add instruction for how to process the output from the function.

By way of an example, if an NL step is “collect Border Gateway Protocol (BGP) summary from the device”, the multi-step configuration schema generator 110 may add a custom summarization instruction to the BGP summary collection step. As such, the refined step may include: (1) a function and (2) custom LLM instruction.

In this example, a first function is to get a device identifier (bgp_summary_step_id) to perform slot filling (input parameters) and a second function to get a summary of the device with an identifier obtained using the first function (bgp_summary_sub_step_id). For example, the refined step may include:

```
{“type: “cli”,
“function name”: “collect_bgp_summary”,
“input_schema”: {
  “type”: “object”,
  “properties”: {
    “device_ip”: {
      “type”: “string”,
      “description”: “IP address of the device”
      }
  }
“required”: [“device_ip”]
}
“output_schema”: {
  “type”: “object”,
  “properties”: {
    “bgp_summary”: {
      “type”: “string”,
      “description”: “BGP summary”
      }
    }
“required”: [“bgp_summary”]
}
“cli”: {
  “cli_template”: show ip bgp summary”
}
}
```

Function binding may improve determinism on data gathering steps and provide deterministic and consistent output. Additionally, run-time error rate may be reduced in performing troubleshooting.

Custom LLM summarization instructions instruct the LLM how to process the output. The LLM may thus process output differently depending on whether the output is for reasoning, data gathering, displaying on a user interface, etc. In a given example, the custom LLM summarization instruction includes:

“Only show information that correspond to neighbors that are down in the summary. Attributes (version, memory use, etc.) that are not needed for neighbor troubleshooting should not be included in the summary.”

Custom LLM instructions may especially be useful when the function output is in a free form response or in an unstructured form and/or when only some of the outputs are needed for responding to the user query. Adding custom LLM instructions may help improve determinism and stability of the output, and particularly, for reasoning steps.

Additionally, in one example embodiment, the multi-step configuration schema generator 110 may perform context window reduction in which the refined steps identify step dependency. That is, the refined step may include an indication of which data is relevant for which subsequent refined step (in a multi-step configuration schema). Output of previous configuration action may be omitted from some subsequent steps and are provided only to the configuration schema steps that need this output.

By way of an example, the BGP summary from the device may be provided to a reasoning step that determines if a BGP to a neighbor is down but not to a reasoning step that deals with device interfaces (LAN or WAN interface). By determining which step needs output of which preceding steps and including these determinations in the configuration schema steps, the token usage is reduced, processing latency is decreased, and accuracy of the output is improved.

In one example embodiment, the multi-step configuration schema generator 110 may further perform dependency mapping using an LLM compiler. Specifically, the multi-step configuration schema generator 110 may determine which steps may be performed in parallel or at substantially same time. For example, the configuration actions involve the following steps:
(1) collect BGP summary from the device,
(2) collect interface description from the device,
(3) collect IP route information from the neighbor,
(4) determine whether BGP to neighbor is still down, and
(5) identify the device interface that leads to the neighbor.

The multi-step configuration schema generator 110 may determine that steps 1-3 may be performed in parallel and steps 4 and 5 may be performed in parallel. By performing dependency mapping, the multi-step configuration schema generator 110 may execute steps 1-3 in parallel and then steps 4 and 5 in parallel. By performing dependency mapping, the multi-step configuration schema generator 110 may lower token usage and decrease the processing latency.

Turning now to FIG. 2B, a diagram is shown depicting an operational flow 250 in which components of the multi-step configuration schema generator 110 generate and validate the multi-step configuration schema 154 of FIG. 2A, according to an example embodiment. The operational flow 250 involves interactions pf components of the multi-step configuration schema generator 110, such as a RAG based function lookup agent 252, a generator agent 254, and a reflection agent 256. The operational flow 250 may further involve a test executor agent 258. In one example embodiment, the network virtual assistant 120 of FIGS. 1A and 1B may be used as the test executor agent 258 that interacts with network/computing equipment and software 132a-m.

The RAG based function lookup agent 252 obtains a user query 260 and the NL plan steps 262a-j, which are steps in the NL plan 152 of FIGS. 1B and 2A. The RAG based function lookup agent 252 is configured to select function(s) from the RAG vector database 112 (not shown) based on each step of the NL plan steps 262a-j. The RAG based function lookup agent 252 uses a step description in the NL plan steps 262a-j to select function(s) based on the function metadata 220, shown in FIG. 2A. As explained above, the function metadata 220 includes input arguments for the input parameters (JSON inputs), expected output schema (JSON outputs), etc.

The generator agent 254 obtains the user query 260 (with data values for the input parameters), a corresponding NL plan step such as an NL plan step 262a, relevant functions 264 selected or generated by the RAG based function lookup agent 252 and relevant functions metadata 266, which includes example JSON input parameters and expected JSON output fields. The generator agent 254 generates a refined step 268 by augmenting each step description with a name and identification of an executable function (configuration action) and corresponding input parameters for the function. In an agentic workflow with reflection, the generator agent 254 first determines and proposes functions to use and the slots (arguments) to use. The generated output (the refined step 268) along with the user query 260 is then provided through the reflection agent 256. Based on a refinement feedback 270 from the reflection agent 256, the generator agent 254 generates final configuration schema steps 280a-j. The generator agent 254 iteratively regenerates configuration actions based on the refinement feedback 270 until the final configuration schema steps 280a-j are generated.

The reflection agent 256 tests and validates the refined step 268 for accuracy and correctness. The reflection agent 256 may be a reflection LLM that validates each function in the relevant functions 264. The reflection agent 256 ensures that an optimal function is selected from the relevant functions 264. Specifically, the reflection agent 256 cross checks the correctness of each selected function, its existence, and the correctness of the selected arguments fields (data values for the input parameters). If not accurate, the reflection agent 256 requests that the generative LLM (the generator agent 254) further refines the selection by regenerating configuration actions for the NL plan step 262a. The reflection agent 256 generates the refinement feedback 270 based on testing the selected function such that the generator agent 254 may iteratively regenerate the configuration actions for each step in a multi-step configuration schema until optimal functions are selected to resolve the technical issue in the user query 260.

To validate the refined step 268, the reflection agent 256 interacts with the test executor agent 258 to test the functions in the refined step 268. The test executor agent 258 obtains the refined step 268, the user query 260, and JSON input 272 that may include data generated from preceding configuration actions (any intermediate step(s) output). The test executor agent 258 then interacts with the network/computing equipment and software 132a-m to perform the configuration actions in the refined step 268. For example, the test executor agent 258 connects to a respective network device and performs commands/operations on this network device. The outcome of performing the configuration action is sent back to the test executor agent 258. The test executor agent 258 may then proceed with adding the outcome (an executing trace) to a response. For example, if a trace file or a network trace output is obtained, which is indicative of whether the configuration action was successfully performed, the test executor agent 258 proceeds with adding the trace to a response. As another example, if the telemetry data and/or KPIs were obtained from this network device, the test executor agent 258 proceeds with adding this telemetry data/KPIs to the response. In short, the test executor agent 258 generates a network trace and JSON output 274, which may include the telemetry data.

In one example embodiment, a human-in-the-loop validations 276 may be performed. The human-in-the-loop validations 276 involve a user analyzing the trace and JSON output 274 and providing a human feedback 278 with respect to the trace and JSON output 274. Based on a final approval from the human validator, the reflection agent 256 may generate the refinement feedback 270. The refinement feedback 270 may indicate that the function(s) are acceptable and are to be added to the final configuration schema steps 280a-j. Eventually, the human-in-the-loop validations 276 may help generate the final output of the refinement vetted out for additional correctness guarantees.

In one or more example embodiments, the multi-step configuration schema generator 110 is trained using a feedback loop having a sample JSON input and a sample JSON output as input parameters, to determine if the generated multi-step configuration schema is correct and includes proper function calls and arguments for each function. The multi-step configuration schema generator 110 may perform an offline workflow and transform the NL plan 152 into the multi-step configuration schema 154 using this iterative LLM based workflow with reflection and (optionally human-in-the-loop) pipelines. The multi-step configuration schema generator 110 transforms each of the NL plan steps 262a-j to a prescriptive configuration action step augmented with the specific function call(s) to be made, as well as specific JSON schema fields to be used for input, and specific JSON schema fields to be selected in the outputs. The multi-step configuration schema generator 110 may generate a plurality of multi-step configuration schemas for troubleshooting by the network virtual assistant 120.

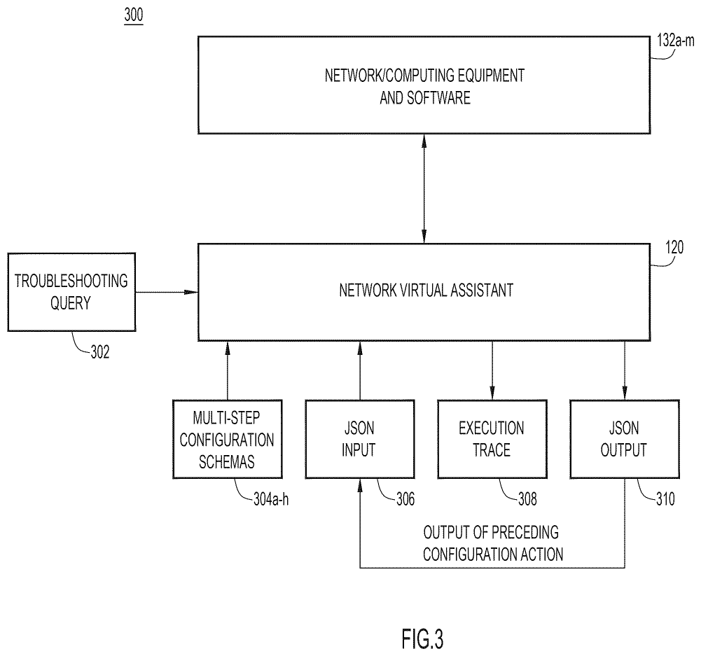

Reference is now made to FIG. 3, which shows a diagram depicting an operational flow 300 by which the network virtual assistant 120 performs troubleshooting to solve a technical issue using a multi-step configuration schema, according to an example embodiment. In the operational flow 300, the network virtual assistant 120 obtains a troubleshooting query 302 to perform troubleshooting on the network/computing equipment and software 132a-m using one of the multi-step configuration schemas 304a-h with JSON input 306 to generate an execution trace 308 and a JSON output 310.

The multi-step configuration schemas 304a-h may be stored in a datastore or a knowledge base, which is accessed by the network virtual assistant 120. That is, when the multi-step configuration schemas 304a-h are curated and available in a repository (datastore), these multi-step configuration schemas 304a-h are looked up for any of incoming troubleshooting queries.

The network virtual assistant 120 selects one of the multi-step configuration schemas 304a-h based on the troubleshooting query 302 and executes the functions in the selected multi-step configuration schema. The network virtual assistant 120 may be a smaller LLM model than that of the multi-step configuration schema generator 110 and executes the selected multi-step configuration schema with more confidence, improved determinism and with lower latency and cost. The network virtual assistant 120 executes each function in the selected schema and may use JSON input 306 generated from a preceding configuration action as input parameters in subsequent configuration actions of the selected schema. The selected multi-step configuration schema includes an indication of whether the JSON input 306 is to include output from preceding configuration actions and if so, which ones.

In one or more example embodiments, the selected multi-step configuration schema includes a JSON input schema (expected input parameters), a JSON output schema (expected output fields), and at least one executable operation or a configuration action to be performed on the network/computing equipment and software 132a-m described in a natural language and in a structured executable format. In some instances, the configuration actions are executed sequentially on the network/computing equipment and software 132a-m. The network virtual assistant 120 generates the execution trace 308, which indicates actions performed on the network device and outcome of performing these actions and the JSON output 310, which indicates operating state or status of the network device such as telemetry data and/or KPIs. Based on the structure of the output, a correct natural language summary is generated to describe the results of troubleshooting.

In short, the network virtual assistant 120 executes one of the multi-step configuration schemas 304a-h selected to response to the troubleshooting query 302. Since the multi-step configuration schemas 304a-h describe the functions and arguments in a JSON schema structure, mistakes in selecting the wrong function and/or using wrong input parameters for the functions may be avoided.

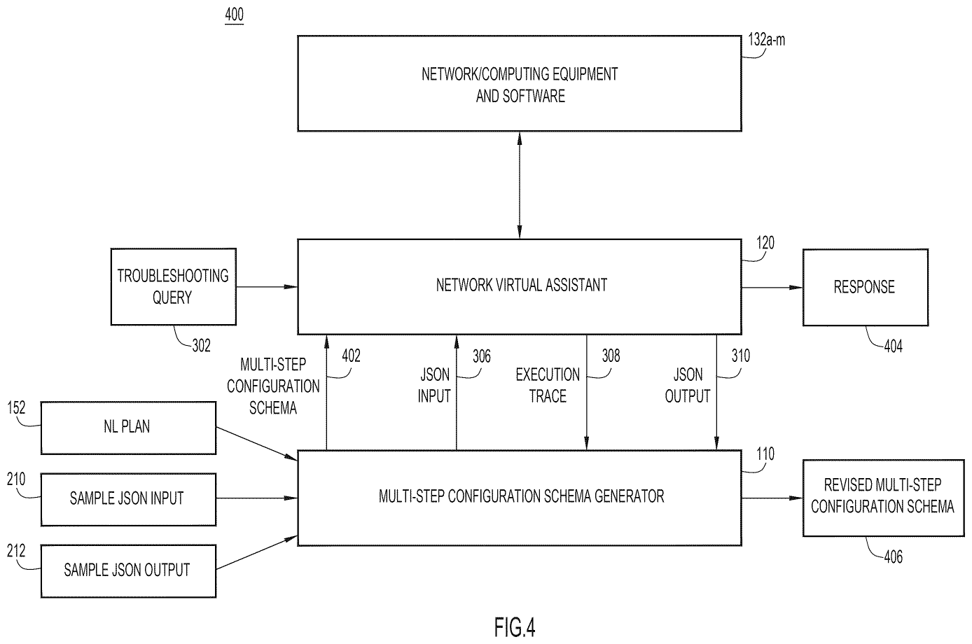

Turning now to FIG. 4, FIG. 4 is a diagram depicting an operational flow 400 in which a runtime feedback loop is performed for improved accuracy in troubleshooting a technical issue, according to an example embodiment. The operational flow 400 involves the multi-step configuration schema generator 110, which generates a multi-step configuration schema 402 based on the NL plan 152 and the network virtual assistant 120, which generates a response 404 to the troubleshooting query 302.

As explained above, based on the NL plan 152, the multi-step configuration schema generator 110 generates a multi-step configuration schema 402. Based on the troubleshooting query 302, the network virtual assistant 120 selects the multi-step configuration schema 402 and based on the sample JSON input 210 and the sample JSON output 212 obtains any missing input values for the input parameters. The network virtual assistant 120 executes the multi-step configuration schema 402 using data from the troubleshooting query 302 and JSON input 306 obtained from executing preceding configuration actions. The network virtual assistant 120 executes the configuration actions on the network/computing equipment and software 132a-m, and generates a response 404 to the troubleshooting query 302. While the response 404 may simply state that the technical issue is resolved, the execution trace 308 and the JSON output 310 are provided to multi-step configuration schema generator 110 such that the multi-step configuration schema generator 110 revises the multi-step configuration schema 402 (changes one or more configuration actions) to generate a revised multi-step configuration schema 406. Such that for next troubleshooting query, the revised multi-step configuration schema 406 is performed and the multi-step configuration schema 402 is discarded.

In short, in addition to generating a natural language summary based on the execution trace 308 and the JSON output 310, the network virtual assistant 120 feeds back this output to the multi-step configuration schema generator 110. The multi-step configuration schema generator 110 then uses this output to further refine the multi-step configuration schema 402 to generate a new multi-step configuration schema i.e., the revised multi-step configuration schema 406. Revising the multi-step configuration schema 402 may involve adding configuration actions or removing arguments from functions and/or changing functions being selected, etc.

The techniques presented herein provide LLM function calling of multi-step natural language execution plans, by a mechanism of NL plan refinement aided by LLMs with reflection support to provide more determinism in the function selection. This is realized without any risk of for hallucination in both function selections as well as slot selections and ensuring the right input and output JSON arguments are selected for each step of the NL plan. The techniques presented herein improve determinism, reduce latency of execution, and provide a cost-effective technique in which smaller efficient LLM models may be deployed at execution.

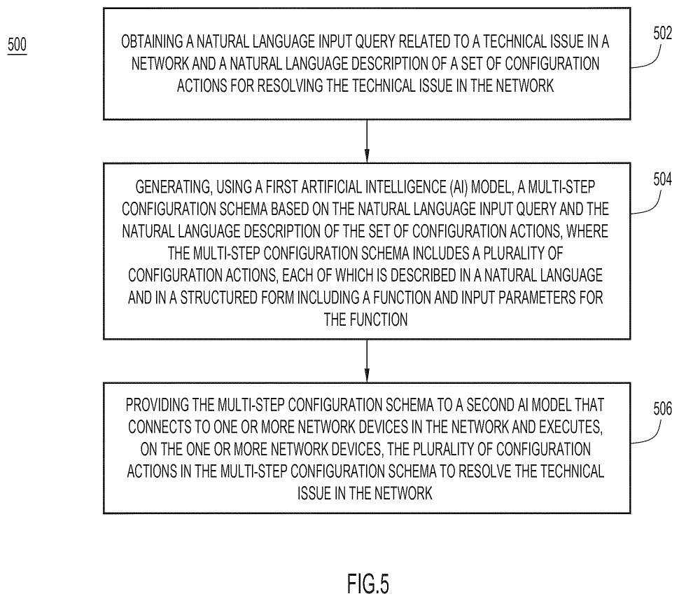

FIG. 5 is a flowchart illustrating a method 500 of generating and performing a multi-step configuration schema in which configuration actions are executed on network devices to resolve a technical issue in a network, according to one or more example embodiments. The method 500 may be performed by a computing device of FIG. 7 and/or one or more servers that implement the system described above with reference to FIGS. 1A, 1B, 2A, 2B, 3, and 4, and/or in cloud.

The method 500 involves at 502, obtaining a natural language input query related to a technical issue in a network and a natural language description of a set of configuration actions for resolving the technical issue in the network.

The method 500 further involves at 504, generating, using a first artificial intelligence (AI) model, a multi-step configuration schema based on the natural language input query and the natural language description of the set of configuration actions. The multi-step configuration schema includes a plurality of configuration actions, each of which is described in a natural language and in a structured form including a function and input parameters for the function.

The method 500 further involves at 506, providing the multi-step configuration schema to a second AI model that connects to one or more network devices in the network and executes, on the one or more network devices, the plurality of configuration actions in the multi-step configuration schema to resolve the technical issue in the network.

According to one or more example embodiments, the second AI model may be smaller than the first AI model.

In one form, each of the plurality of configuration actions may include an input schema for the input parameters and an output schema for an expected output. The method 500 may further include determining, for each of the plurality of configuration actions, whether data for the input parameters is present based on the input schema. The data may be extracted from the natural language input query or from an output from performing a preceding configuration action in the multi-step configuration schema. Based on determining that the data is missing at least one value for the input parameters, the method 500 may further include generating a follow-up query to obtain the at least one value.

In one instance, the method 500 may further involve executing the function to perform a configuration action on the one or more network devices in the network using the input parameters and generating a network trace output based on executing the function.

In one or more example embodiments, the method 500 may further involve iteratively regenerating the multi-step configuration schema based on whether the network trace output matches the output schema.

In another form, the operation 504 of generating the multi-step configuration schema may involve, for each configuration action, performing a retrieval augmented generation (RAG) based lookup operation to select the function in a vector datastore based on the natural language description. The vector datastore may store function metadata including a plurality of function identifications, each with a corresponding function description, the input parameters, and at least one expected output field.

According to one or more example embodiments, the plurality of configuration actions may include at least one of a command line interface function, a data modeling language function, or an application programming interface call. The operation 504 of generating the multi-step configuration schema may include augmenting the multi-step configuration schema with one or more instructions for processing an output from the function. The operation 504 of generating the multi-step configuration schema may further include refining the multi-step configuration schema by mapping the output from the function to at least one subsequent configuration action of the multi-step configuration schema and by mapping one or more dependencies between the plurality of configuration actions in the multi-step configuration schema.

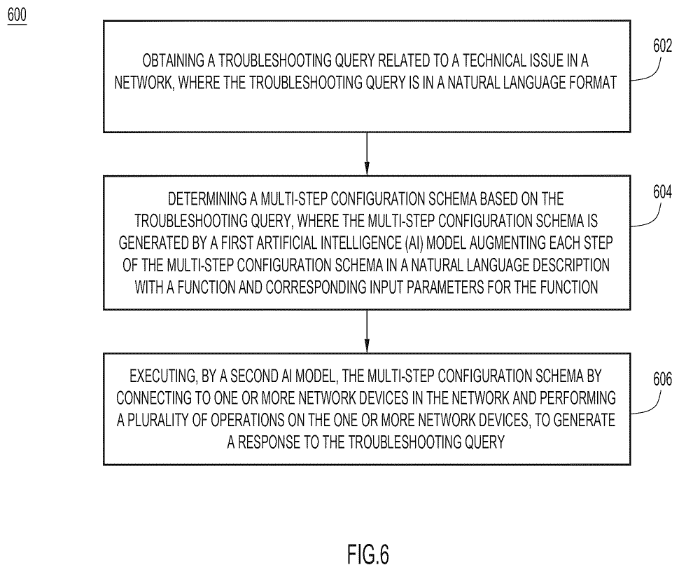

FIG. 6 is a flowchart illustrating a method 600 of troubleshooting a technical issue in a network by connecting to network devices and performing operations of a multi-step configuration schema on these devices, according to one or more example embodiments. The method 600 may be performed by a computing device of FIG. 7 and/or one or more servers that implement the system described above with reference to FIGS. 1A, 1B, 2A, 2B, 3, and 4, and/or in cloud.

The method 600 involves at 602, obtaining a troubleshooting query related to a technical issue in a network. The troubleshooting query is in a natural language format.

The method 600 further involves at 604, determining a multi-step configuration schema based on the troubleshooting query. The multi-step configuration schema is generated by a first artificial intelligence (AI) model augmenting each step of the multi-step configuration schema in a natural language description with a function and corresponding input parameters for the function.

The method 600 further involves at 606, executing, by a second AI model, the multi-step configuration schema by connecting to one or more network devices in the network and performing a plurality of operations on the one or more network devices, to generate a response to the troubleshooting query.

According to one or more example embodiments, each step in the multi-step configuration schema may further be augmented with an expected output field. The method 600 may further involve generating the response to the troubleshooting query based on matching an output from executing the function in a step of the multi-step configuration schema with the expected output field for the step.

In one form, the method 600 may further involve generating a trace file based on executing a plurality of functions in the multi-step configuration schema and adding the trace file to the response for the troubleshooting query.

According to one or more example embodiments, the second AI model may be smaller than the first AI model.

In another form, the operation 604 of determining the multi-step configuration schema may involve selecting, by the second AI model, the multi-step configuration schema from a plurality of multi-step configuration schemas generated by the first AI model, based on the troubleshooting query.

In yet another form, the operation 606 of executing the multi-step configuration schema may include executing a first operation in the multi-step configuration schema to generate an output and executing s second operation in the multi-step configuration schema based on the output from the first operation.

According to one or more example embodiments, each step in the multi-step configuration schema may involve an input schema for the corresponding input parameters and an output schema for an expected output. The method 600 may further involve determining, for each step in the multi-step configuration schema, whether data for the corresponding input parameters is present based on the input schema. The data is extracted from the troubleshooting query or from executing one of preceding operations of the multi-step configuration schema. The method 600 may further include, based on determining that the data is missing at least one value for the corresponding input parameters, generating a follow-up query to obtain the at least one value.

FIG. 7 is a hardware block diagram of a computing device 700 that may perform functions associated with any combination of operations in connection with the techniques depicted in FIGS. 1A, 1B, 2A, 2B, and 3-6, according to various example embodiments, including, but not limited to, operations of the multi-step configuration schema generator 110, the network virtual assistant 120, the enterprise service cloud 122, a network device of the network/computing equipment and software 132a-m, and/or a user device of the user devices 140a-k. It should be appreciated that FIG. 7 provides only an illustration of one example embodiment and does not imply any limitations with regard to the environments in which different embodiments may be implemented. Many modifications to the depicted environment may be made.

In at least one embodiment, computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with one or more memory elements 704 (or vice versa) or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, and/or any other I/O port(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 716, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory, a network interface configured to communicate in a network, and a processor coupled to the network interface. The processor is configured to perform operations that include obtaining a natural language input query related to a technical issue in the network and a natural language description of a set of configuration actions for resolving the technical issue in the network. The operations further include generating, using a first artificial intelligence (AI) model, a multi-step configuration schema based on the natural language input query and the natural language description of the set of configuration actions. The multi-step configuration schema includes a plurality of configuration actions, each of which is described in a natural language and in a structured form including a function and input parameters for the function. The operations further include providing the multi-step configuration schema to a second AI model that connects to one or more network devices in the network and executes, on the one or more network devices, the plurality of configuration actions in the multi-step configuration schema to resolve the technical issue in the network.

In yet another example embodiment, an apparatus is provided, which includes a memory, a network interface configured to communicate in a network, and a processor coupled to the network interface. The processor is configured to perform operations including obtaining a troubleshooting query related to a technical issue in a network. The troubleshooting query is in a natural language format. The operations further include determining a multi-step configuration schema based on the troubleshooting query. The multi-step configuration schema is generated by a first artificial intelligence (AI) model augmenting each step of the multi-step configuration schema in a natural language description with a function and corresponding input parameters for the function. The operations further include executing, by a second AI model, the multi-step configuration schema by connecting to one or more network devices in the network and performing a plurality of operations on the one or more network devices, to generate a response to the troubleshooting query.

In yet another example embodiment, one or more non-transitory computer readable storage media encoded with instructions are provided. When the media is executed by a processor, the instructions cause the processor to execute a method that includes obtaining a natural language input query related to a technical issue in a network and a natural language description of a set of configuration actions for resolving the technical issue in the network. The method further includes generating, using a first artificial intelligence (AI) model, a multi-step configuration schema based on the natural language input query and the natural language description of the set of configuration actions. The multi-step configuration schema includes a plurality of configuration actions, each of which is described in a natural language and in a structured form including a function and input parameters for the function. The method further includes providing the multi-step configuration schema to a second AI model that connects to one or more network devices in the network and executes, on the one or more network devices, the plurality of configuration actions in the multi-step configuration schema to resolve the technical issue in the network.

In yet another example embodiment, one or more non-transitory computer readable storage media encoded with instructions are provided. When the media is executed by a processor, the instructions cause the processor to execute a method that includes obtaining a troubleshooting query related to a technical issue in a network. The troubleshooting query is in a natural language format. The method further includes determining a multi-step configuration schema based on the troubleshooting query. The multi-step configuration schema is generated by a first artificial intelligence (AI) model augmenting each step of the multi-step configuration schema in a natural language description with a function and corresponding input parameters for the function. The method further includes executing, by a second AI model, the multi-step configuration schema by connecting to one or more network devices in the network and performing a plurality of operations on the one or more network devices, to generate a response to the troubleshooting query.

In yet another example embodiment, a system is provided that includes the devices and operations explained above with reference to FIGS. 1A, 1B, 2A, 2B, and 3-7.

The programs described herein (e.g., control logic 720) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 706 and/or memory elements(s) 704 can store data, software, code, instructions (e.g., processor instructions), logic, parameters, combinations thereof, and/or the like used for operations described herein. This includes the storage 706 and/or memory elements(s) 704 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining a natural language input query related to a technical issue in a network and a natural language description of a set of configuration actions for resolving the technical issue in the network;
generating, using a first artificial intelligence (AI) model, a multi-step configuration schema based on the natural language input query and the natural language description of the set of configuration actions, wherein the multi-step configuration schema includes a plurality of configuration actions, each of which is described in a natural language and in a structured form including a function and input parameters for the function; and
providing the multi-step configuration schema to a second AI model that connects to one or more network devices in the network and executes, on the one or more network devices, the plurality of configuration actions in the multi-step configuration schema to resolve the technical issue in the network.

2. The method of claim 1, wherein the second AI model is smaller than the first AI model.

3. The method of claim 1, wherein each of the plurality of configuration actions includes an input schema for the input parameters and an output schema for an expected output, and further comprising:
determining, for each of the plurality of configuration actions, whether data for the input parameters is present based on the input schema, wherein the data is extracted from the natural language input query or from an output from performing a preceding configuration action in the multi-step configuration schema; and
based on determining that the data is missing at least one value for the input parameters, generating a follow-up query to obtain the at least one value.

4. The method of claim 3, further comprising:
executing the function to perform a configuration action on the one or more network devices in the network using the input parameters; and
generating a network trace output based on executing the function.

5. The method of claim 4, further comprising:
iteratively regenerating the multi-step configuration schema based on whether the network trace output matches the output schema.

6. The method of claim 1, wherein generating the multi-step configuration schema includes:
for each configuration action, performing a retrieval augmented generation (RAG) based lookup operation to select the function in a vector datastore based on the natural language description, wherein the vector datastore stores function metadata including a plurality of function identifications, each with a corresponding function description, the input parameters, and at least one expected output field.

7. The method of claim 1, wherein the plurality of configuration actions include at least one of a command line interface function, a data modeling language function, or an application programming interface call and wherein generating the multi-step configuration schema includes:
augmenting the multi-step configuration schema with one or more instructions for processing an output from the function; and
refining the multi-step configuration schema by mapping the output from the function to at least one subsequent configuration action of the multi-step configuration schema and by mapping one or more dependencies between the plurality of configuration actions in the multi-step configuration schema.

8. A method comprising:
obtaining a troubleshooting query related to a technical issue in a network, wherein the troubleshooting query is in a natural language format;
determining a multi-step configuration schema based on the troubleshooting query, wherein the multi-step configuration schema is generated by a first artificial intelligence (AI) model augmenting each step of the multi-step configuration schema in a natural language description with a function and corresponding input parameters for the function; and
executing, by a second AI model, the multi-step configuration schema by connecting to one or more network devices in the network and performing a plurality of operations on the one or more network devices, to generate a response to the troubleshooting query.

9. The method of claim 8, wherein each step in the multi-step configuration schema is further augmented with an expected output field, and further comprising:
generating the response to the troubleshooting query based on matching an output from executing the function in a step of the multi-step configuration schema with the expected output field for the step.

10. The method of claim 8, further comprising:
generating a trace file based on executing a plurality of functions in the multi-step configuration schema; and
adding the trace file to the response for the troubleshooting query.

11. The method of claim 8, wherein the second AI model is smaller than the first AI model.

12. The method of claim 8, wherein determining the multi-step configuration schema includes:
selecting, by the second AI model, the multi-step configuration schema from a plurality of multi-step configuration schemas generated by the first AI model, based on the troubleshooting query.

13. The method of claim 8, wherein executing the multi-step configuration schema includes:
executing a first operation in the multi-step configuration schema to generate an output; and
executing s second operation in the multi-step configuration schema based on the output from the first operation.

14. The method of claim 8, wherein each step in the multi-step configuration schema includes an input schema for the corresponding input parameters and an output schema for an expected output, and further comprising:
determining, for each step in the multi-step configuration schema, whether data for the corresponding input parameters is present based on the input schema, wherein the data is extracted from the troubleshooting query or from executing one of preceding operations of the multi-step configuration schema; and
based on determining that the data is missing at least one value for the corresponding input parameters, generating a follow-up query to obtain the at least one value.

15. An apparatus comprising:
a network interface to communicate in a network; and
a processor coupled to the network interface and configured to perform operations comprising:
obtaining a natural language input query related to a technical issue in the network and a natural language description of a set of configuration actions for resolving the technical issue in the network;
generating, using a first artificial intelligence (AI) model, a multi-step configuration schema based on the natural language input query and the natural language description of the set of configuration actions, wherein the multi-step configuration schema includes a plurality of configuration actions, each of which is described in a natural language and in a structured form including a function and input parameters for the function; and
providing the multi-step configuration schema to a second AI model that connects to one or more network devices in the network and executes, on the one or more network devices, the plurality of configuration actions in the multi-step configuration schema to resolve the technical issue in the network.

16. The apparatus of claim 15, wherein the second AI model is smaller than the first AI model.

17. The apparatus of claim 15, wherein each of the plurality of configuration actions includes an input schema for the input parameters and an output schema for an expected output, and further comprising:
determining, for each of the plurality of configuration actions, whether data for the input parameters is present based on the input schema, wherein the data is extracted from the natural language input query or from an output from performing a preceding configuration action in the multi-step configuration schema; and
based on determining that the data is missing at least one value for the input parameters, generating a follow-up query to obtain the at least one value.

18. The apparatus of claim 17, wherein the processor is further configured to perform:
executing the function to perform a configuration action on the one or more network devices in the network using the input parameters; and
generating a network trace output based on executing the function.

19. The apparatus of claim 18, wherein the processor is further configured to perform:
iteratively regenerating the multi-step configuration schema based on whether the network trace output matches the output schema.

20. The apparatus of claim 15, wherein the processor is configured to generate the multi-step configuration schema by performing, for each configuration action, a retrieval augmented generation (RAG) based lookup operation to select the function in a vector datastore based on the natural language description, wherein the vector datastore stores function metadata including a plurality of function identifications, each with a corresponding function description, the input parameters, and at least one expected output field.
